(19) United States
(12) Patent Application Publication
(10) Pub. No.: US 2010/0206612 A1
(43) Pub. Date: Aug. 19, 2010

(54) COILED RIBBON AS CONDUCTOR FOR STIMULATION ELECTRODES

(75) Inventor: Herwig Schiefer, Frankfurt (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: W. C. HERAEUS GMBH, Hanau (DE)

(21) Appl. No.: 12/708,269

(22) Filed: Feb. 18, 2010

(30) Foreign Application Priority Data
Feb. 19, 2009 (DE) 10 2009 009 558.6

(51) Int. Cl. H01B 7/00; H01R 43/00; H01B 5/00; B32B 15/01

(52) U.S. Cl. 174/119 R; 29/885; 174/126.1; 428/642

(57) ABSTRACT

One aspect is a coil including a laminate having metal layers. The coil is configured for the electrical connection of stimulation electrodes. One of the metal layers exhibits good electrical conductivity and another metal layer great mechanical strength.

### CROSS-REFERENCE TO RELATED APPLICATIONS

This Utility Patent Application claims priority to German Patent Application No. DE 10 2009 009 558.6, filed on Feb. 19, 2009, which is incorporated herein by reference. This Patent Application is also related to Utility Patent Application filed on even date herewith, entitled “ELECTRICALLY CONDUCTING MATERIALS, LEADS, AND CABLES FOR STIMULATION ELECTRODES” having Attorney Docket No. W683.102.101/P11043 US.

### BACKGROUND

One aspect herein refers to cables for stimulation electrodes.

Electrical leads for stimulation electrodes for the purpose of cardial stimulation or neurostimulation must maintain their function for the entire time that the implant remains in the body. They must be biocompatible, electrically conducting, and ductile, but also exhibit great mechanical tensile strength.

Due to the high mechanical stresses, which affect the electrical leads of the stimulation electrodes while in the human body, for example, through continually recurring cardiac contractions, the materials for said electrical leads are exposed to constant alternating flexural stress.

Usually, such cables are coated with a silicone or PU layer. Clad materials with a core of pure, well conducting material, such as silver, gold, copper, or aluminum have become prevalent as conductors, whereby silver is most commonly used. As coating materials, cobalt alloys, for example, have prevailed, especially MP35N® (essentially Co—Cr—Ni—Mo, standardized in accordance with ASTM F562). For some applications, where a somewhat lower conductivity suffices, cables and coiled wires made of MP35N® full material are utilized. However, it has been illustrated that Co leads to aging of the surrounding plastic.

U.S. Pat. No. 6,191,365 discloses medical devices with numerous coiled and drawn wires.

U.S. Pat. No. 6,278,057 discloses coiled and drawn wires, one of which, at least, consists of a nickel-titanium alloy. Additional wires contain stainless steel, platinum, gold, silver, copper, aluminum, nickel, chromium, platinum, iridium, or tungsten.

EP 0 929 343 describes an electrode cable for electrical stimulation made of coiled wires with a conductive core material of silver, gold, aluminum, copper, or platinum, a material with high strength, such as the cobalt alloy MP35N®, and a silicone or PU-based insulating material. The cable has a diameter of 200 μm.

EP 1 718 363 discloses a twisted and bundled wire configuration, which is drawn to the required diameter and coated with insulating material.

U.S. Pat. No. 7,138,582 discloses metallic conductor bundles (so-called leads) made of modified MP35N®, a cobalt alloy with decreased titanium nitrite inclusions.

U.S. Patent Application No. 2006/283621 discloses bundles of aluminum wires with a PVD coating of tin or zinc.

U.S. Pat. No. 5,796,044 discloses various configurations of wires for a so-called biomedical lead, consisting of a conductive wire and an insulating mantle.

U.S. Pat. No. 5,796,044 discloses a conductor for cardiac pacemakers with a Teflon/silicone jacket.

EP 1 827 575 discloses a configuration, in which a wire core consists of silver and is surrounded by an insulating metal wire made of nickel titanium, MP35N®, titanium, or titanium alloy.

U.S. Pat. No. 7,020,947 discloses a metal wire with filaments for biomedical application. Thereto, holes are drilled into a cylinder, conductive material inserted therein, and a wire drawn therefrom. A biocompatible layer forms the outer skin.

WO 2008/054259 uses an electrically conductive ribbon, which is feather-like coiled.

The term “implantable stimulation lead” is supposed to describe the meaning of the word “lead,” which is designated as a technical term for such electrical connections between distal and proximal ends of a cable. A lead is a medical electrical cable with proximal and distal ends for the electrical connection between a device for stimulation and an electrode connected to said device. Leads are usually designed for a plug-in connection with the device.

The electrical conductor inside the lead is a stranded wire and/or at least one coiled wire and outwardly electrically insulated, for example, as cable or a coil, which is surrounded by an insulation sleeve.

A stranded wire consists of a multitude of wires twisted around each other and is, therefore, a flexible conductor. The large number of wires provides a redundancy with regard to the function of the electrical conductivity in the event of a wire breakage.

A clad material for the medical electrical lead consists of a core made of a material with high electrical conductivity, for example, Ag, Au, Pt, Cu, Al, and a biocompatible coating with good mechanical properties, for example, MP35N®.

In a cable for the medical electrical lead, a stranded wire or a coiled wire is embedded in an electrical plastic insulation (for example, polyurethane, ETFE, PTFE, silicone).

If an electrical lead to a stimulation electrode, the cable or coiled wire of which exhibits an MP35N® outer surface, is coated with polyurethane for the purpose of electrical insulation, the elements Cr, Co, and Mo, contained in MP35N®, cause an oxidative degradation of the surrounding PU layer. This was described in EP 0 329 112 correspondingly. Therein, the degradation was decreased through the coating of the metallic conductor with an inert coating of Pt, for example.

With decreasing wire diameter, for example, during the processing of clad materials into cables, the wall thickness of the MP35N® jacket, for example, becomes very thin, that is, it drops below a thickness of approximately 5-10 μm. Contaminants in the form of inclusions, frequently occurring in pyro-metallurgical material, can act as trigger for breakage through permanent, constantly changing stress as it occurs through body or organ movement, cracks in the wire can form which lead to failure of the wire and, consequently, the cable.

The described clad materials are manufactured into wire through core boring of a cylindrical full material, subsequent tube manufacturing, insertion of the core material into the tube and concluding drawing of the compound. Contaminants in the form of metal residues and particles in the jacket, in the core, or on the boundary between jacket and core remain in the material during wire manufacture and can lead to significant problems during the drawing process itself as well as the subsequent application.

Due to permanent, consistent stress, cracks can form in the core as well as the jacket material.

Furthermore, an aging process of the material occurs with the mostly used MP35N®. Through a phase transformation of the crystalline structure at room temperature, material embrittlement occurs, that is, an increase in strength occurs, however, the elasticity of the material decreases simultaneously. This may result in unforeseeable failure of the material.

For these and other reasons there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates the manufacture of a 2-layered laminate through roll cladding.

FIG. 2 illustrates a ribbons formed into a coil.

FIG. 3 illustrates a coiled ribbon, fused with plastic.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

One aspect herein consists of further improving the reliability, for example, the corrosion stability, the workability and the mechanical stability of medical cables for stimulation electrodes.

For the solution of said task, good electrical conductors are laminated with metals with a great mechanical ability to withstand stress.

According to one embodiment, good electrical conductors, for example, silver, gold, copper, aluminum, or platinum, are laminated with a material with great mechanical strength.

Metal alloys from the system tantalum, niobium, tungsten, and zirconium, or cobalt-chromium alloys, for example, from the system Co—Cr—Ni—Mo, are suited as materials with excellent mechanical strength. In one embodiment, said Co—Cr alloys are alloys in accordance with standard ASTM 562. Precipitation hardening steels, such as titanium and titanium alloys are also suitable.

For example, for the manufacture of laminated ribbons, at first,
ribbons made of a Ta or Nb metal with high purity and high electrical conductivity are doped or alloyed, subsequently exhibiting a substantially higher mechanical strength while maintaining good electrical conductivity;
ribbons made of alloys with excellent mechanical strength, for example, on the basis of the elements tantalum, niobium, tungsten, molybdenum, and zirconium, are used;
ribbons made of a metal with high purity and good electrical conductivity, are embedded, for example, sheathed, wrapped, or laminated, in materials on Ta or Nb basis with excellent strength.

According to one embodiment, an implantable stimulation lead contains a coil, a metallic composite or a cable as described below.

Proven implantable stimulation leads contain on the proximal end a plug serving as connection to a pacemaker, an implantable defibrillator, a peripheral muscle stimulator, or a neurostimulator.

Coils with a layer on the basis of tantalum or niobium, according to one embodiment, exhibit excellent mechanical properties with regard to the required flexibility for a connection between an electrical stimulation device, for example, a pacemaker, defibrillator, etc., connected at the proximal end, and an electrode connected at the distal end of the coil. However, with regard to materials with comparable good mechanical properties, coils on the basis of tantalum or niobium exhibit a significantly higher conductivity. Consequently, electrical conductivity of the connection can be improved and precious metal saved. According to one embodiment, the possibility of providing electrical conductors on the basis of tantalum or niobium is presented. Furthermore, good electrical conductors, for example, made from silver or gold, can be embedded between ribbons on the basis of tantalum or niobium, for example, through coils of laminates with an outer side on the basis of tantalum or niobium as compound, for example, as 2-layered laminate or a sandwich structure with at least 3 layers.

Where applicable, additional good conductors, for example, made of silver, are surrounded by metal coils on tantalum or niobium basis, for example, shielded from an outer layer of the coil or embedded in a sandwich assembly.

According to one embodiment, a tantalum or niobium-based metal with a strength greater than 1000 MPa, for example, greater than 1200 MPa, replaces the application of MP35N®. With a specific electric resistance below 100 μΩcm, for example, below 50 μΩcm, for example, below 20 μΩcm, the tantalum or niobium-based metal already contributes significantly to the improvement of the electrical conductivity, or, accordingly, saves precious metal, for example, silver or gold. At a specific electric resistance below 20 μΩcm, the tantalum or niobium-based metal is a good conductor with distinctly better mechanical properties.

In one embodiment, the tantalum or niobium-based metal is doped with at least one element from the group P, B, O, C, N, Si, F, Zr, Y, La, Ce, Pr, Nd, Sm, Eu, Gd, Tb, Dy, Ho, Er, Tm, Yb, and Lu, and exhibits a specific electric resistance <20 μΩcm. Such doped niobium or tantalum is called fine-grained stabilized tantalum or niobium. In one embodiment, the tantalum or niobium-based metal is a gradient material, surface-treated with one of the above elements. At a specific electric resistance <20 μΩcm, the doped niobium or tantalum can be used as good electrical conductor, for example, as a replacement for silver or gold. Thereby, niobium and tantalum are more biocompatible than silver.

In one embodiment, the tantalum or niobium-based metal is alloyed with at least one other element from the group niobium, tantalum, tungsten, zirconium, and molybdenum, for example, 0.1-70% w/w Nb, 0.1-30% w/w of at least one element from the group W, Zr, Mo, and less than 5% from at least one of the elements from the group hafnium, rhenium, lanthanides, cerium, and the rest Ta. These alloys exhibit good mechanical properties and, compared to MP35N® (with a specific electric resistance of 103 μΩcm) add significantly to the electrical conductivity.

In one embodiment, metallic conductors with high electrical conductivity, for example, conductors made of copper, silver, gold, or aluminum, are surrounded by a metal with greater mechanical strength. In one embodiment, the metal with the high electrical conductivity has a specific electric resistance of less than 12 μΩcm.

In one embodiment, the conductor of a stranded wire consists of a metal, for example, silver, with a better conductivity than the tantalum or niobium-based metal, and is surrounded by a body made of a tantalum or niobium-based metal, for example, a jacket or a coil or several coils.

Whether the conductor made of the metal with the higher electrical conductivity is surrounded by doped tantalum or niobium or by a body made from a niobium or tantalum alloy depends on the requirements regarding diameter, electrical conductivity, and mechanical resilience.

A coil or helix must serve as electrical connection between an electrode and an electrical stimulation device, such as a pacemaker, defibrillator, etc., that is, electrically connect the stimulation device at the proximal end of the coil with the electrode at the distal end of the coil. According to one embodiment, such a coil is made of a tantalum or niobium-based metal. In one embodiment, the tantalum or niobium-based metal is doped with an element from the group P, B, O, C, N, Si, F, Y, La, Ce, Pr, Nd, Sm, Eu, Gd, Tb, Dy, Ho, Er, Tm, Yb, and Lu in such a way that it exhibits a specific electric resistance of <20 μΩcm. In one embodiment, the tantalum or niobium-based metal is a gradient material surface-treated with a nonmetal. In a further embodiment, the tantalum or niobium-based metal is alloyed with at least one other element from the group niobium, tantalum, tungsten, zirconium, and molybdenum in order to achieve a strength greater than 1200 MPa.

Tantalum or niobium-based metal coils are applicable as an alternative to stranded wires.

The material properties of the tantalum or niobium-based materials, for example, mechanical strength and electrical conductivity, correspond with the doped metals, alloys, gradient materials, and clad materials described elsewhere herein.

Furthermore, the technique described for cables and stranded wires can also be realized in the form of coils.

In this context, a metallic composite material is also part of one embodiment herein, whereby a conductor is surrounded, for example, embedded, and the embedding consists of a tantalum or niobium-based metal, whereby the compound is suited to serve as an electrical connection between an electrical stimulation device, such as a pacemaker, defibrillator, etc., which is connected to the proximal end of the metallic composite material, and an electrode connected to the distal end of the metallic composite material.

In one embodiment, the tantalum or niobium-based metal of the composite material exhibits a strength of more than 1000 MPa and a specific electric resistance of <200 μΩcm. Doping of a tantalum or niobium-based metal with an element from the group P, B, O, C, N, Si, F, Zr, Y, La, Ce, Pr, Nd, Sm, Eu, Gd, Tb, Dy, Ho, Er, Tm, Yb, and Lu facilitates a specific electric resistance of <20 μΩcm. This facilitates a compound, for example, a sandwich assembly, in which an electrical conductor made of tantalum or niobium-based metal is embedded.

With a tantalum or niobium-based metal, which is alloyed with at least one element from the group niobium, tantalum, tungsten, zirconium, and molybdenum, a strength greater than 1000 MPa can be achieved, for example, a strength greater than 1200 MPa.

A lead for stimulation electrodes, according to one embodiment, contains within its electrical insulation, for example, a metal coil,
which, in the case of a coiled ribbon, exhibits a layer which consists of a tantalum or niobium-based metal;
which, in the case of a metal compound, for example, a sandwich assembly, contains at least one tantalum or niobium-based metal, for example, with a greater mechanical strength than the other metals contained therein.

In the simplest case scenario, the electrical lead for stimulation electrodes consists of a coiled electrical conductor with insulation. Such an electrical lead for stimulation electrodes may also contain a single coiled conductor.

In a cable for stimulation electrodes, whereby within the insulation a metal with good electrical conductivity is surrounded by a metal with great mechanical strength, for example, embedded or outwardly shielded, the metal with great mechanical strength, according to one embodiment, is an alloy on the basis of the elements tantalum, niobium, tungsten, and zirconium, or a cobalt-chromium alloy, for example, from the system Co—Cr—Ni—Mo, or precipitation hardening steels, or titanium, or titanium alloys. A gradient material on the basis of the elements tantalum or niobium has proven successful, whereby only the surface was treated through doping with at least one element from the group P, B, O, C, N, Si, F, Zr, Y, La, Ce, Pr, Nd, Sm, Eu, Gd, Tb, Dy, Ho, Er, Tm, Yb, and Lu, subsequently exhibiting increased strength.

The metal with good conductivity is, in one embodiment, an element of high purity, for example, silver, copper, aluminum, gold, or platinum.

Compared to MP35N®, precious metal can be saved, according to one embodiment, because the alloys, according to the embodiment, exhibit improved conductivity when compared to MP35N®, therefore, less precious metal is needed for the required conductivity of the compound.

Furthermore, according to one embodiment, the applicable alloys for embedding or shielding of good conductors are already X-ray opaque due to refraction metals, therefore, efforts for a visualization in the X-ray image are no longer required, according to the embodiment.

In one embodiment, good electrical conductors, for example, made from silver, gold, copper, aluminum, or platinum, are laminated with a material of high mechanical strength. Suitable materials with excellent mechanical strength are metal alloys from the system tantalum, niobium, tungsten, and zirconium. Said metal laminate is formed into a coil and sheathed with electrically insulating plastic or initially sheathed with electrically insulating plastic and then formed into a coil. The coil, for example, the one initially sheathed with plastic and subsequently coiled, is as coiled ribbon, in one embodiment, sheathed a second time with plastic. In one embodiment, a cavity remains in the center of the coiled ribbon, thereby providing for a hose-like cable.

In one embodiment, cables for permanently implanted medical applications are provided as cables with outer insulation. The outer insulation consists of a biocompatible plastic, for example, on the basis of an organic polymer, which possibly contains fillers. Silicone and PU-based plastics as well as fillers for increasing the X-ray opacity, or for the modification of the electrical conductivity in certain frequency ranges, have proven successful.

For embedding or laminating of the good conducting metal, alloys are well-suited, for example, cobalt-free alternative materials to MP35N® standards:

TaNbW, TaNbZr, TaNbWZr, fine-grained stabilized Ta, fine-grained stabilized Nb, phosphor-doped Nb, NbZr1, TaW7.5, TaW10, precipitation hardening steels (17-7, 17-5), phosphor-doped TaNbW, boron-doped TaNbW, oxygen-doped TaNbW, zirconium-doped TaNbW, gradient materials (for example, externally oxygen-doped NbZr, or externally oxygen-doped TaNbW).

Electrical leads, consisting of ribbons, the profiles of which correspond with those of extra-fine wires with diameters of less than 200 μm, for example, between 10 and 100 μm, for example, 15 to 50 μm, have proven successful.

For achieving high mechanical strength and low electric resistance, electrical leads for stimulation electrodes, which contain a metal ribbon with good electrical conductivity and a metal ribbon with great mechanical strength embedded in a plastic insulation, for example, made of silicone or PU, exhibit, according to one embodiment, an alloy on the basis of the elements tantalum or niobium, for example, from the system tantalum, niobium, tungsten, molybdenum, and zirconium, as the metal with high mechanical strength.

As gradient material, a specific electric resistance <20 μΩcm for the alloy with great strength is achievable.

According to one embodiment, a stimulation electrode is provided with an electrically conductive lead for the conduction of electrical signals to electrode poles at the distal end of the stimulation electrode, the lead of which exhibits a strength of more than 1000 MPa and a specific electric resistance of less than 100 μΩcm, for example, less than 20 μΩcm. According to one embodiment, the electrical lead thereto contains a tantalum or niobium-based metal ribbon.

In one embodiment,
the electrical lead consists of fine-grained stabilized tantalum or niobium and exhibits a specific electric resistance <20 μΩcm, for example, less than 17 μΩcm;
the electrical lead consists of a tantalum or niobium alloy, which contains at least one other element from the group niobium, tantalum, tungsten, zirconium, and molybdenum;
the electrical lead made of tantalum or niobium is a gradient material which is wire surface-treated with at least one element from the group P, B, O, C, N, Si, F, Zr, Y, La, Ce, Pr, Nd, Sm, Eu, Gd, Tb, Dy, Ho, Er, Tm, Yb, and Lu;
the electrical lead exhibits a metal, such as Ag, Au, Cu, or Al, with better conductivity than the tantalum or niobium-based metal, whereby the metal with better conductivity is surrounded by the tantalum or niobium-based metal, for example, embedded or sheathed.

In one embodiment, the metal ribbon with the higher electrical conductivity is embedded in fine-grained stabilized tantalum or niobium or a niobium or tantalum alloy, which contains at least one other element from the group niobium, tantalum, tungsten, zirconium, and molybdenum.

During fine-grain stabilization, a fine-grained structure is produced through doping with impurity atoms, which leads to increased strength of the material. In these materials, said impurities stabilize the grains in such a way that unwanted grain growth is suppressed even at prolonged temperature manipulations. Aside from their mechanical strength, fine-grained stabilized tantalum or niobium exhibit good electrical conductivity and can, therefore, further contribute to the conductivity of the entire lead, when compared to materials used heretofore for increasing strength.

For doping, at least one element from the group P, B, O, C, N, Si, F, Zr, Y, La, Ce, Pr, Nd, Sm, Eu, Gd, Tb, Dy, Ho, Er, Tm, Yb, and Lu is used. Proven dopings are in the range between 50-1000 ppm per element, for example, in the range between 300-500 ppm, with the sum of all doping elements in the range between 300-10,000 ppm, for example, in the range between 500-5,000 ppm.

According to one embodiment, a coil, a metallic composite, a cable, or an implantable stimulation lead is used for a cardiac pacemaker, implantable defibrillator, neurostimulator, or peripheral muscle stimulator. Laminates, which consist of ribbons, the profiles of which correspond with those of extra-fine wires with diameters of less than 200 μam, for example, between 10 and 100 μm, have proven successful as electrical leads. In one embodiment, the profile of the ribbons forming the laminates corresponds with that of extra-fine wires with diameters of 15 to 50 μm. Correspondingly, the profiles of the laminates are twice or three times greater.

The metal laminate is formed into a coil and coated with an electrically insulating plastic, or initially coated with an electrically insulating plastic and subsequently formed into a coil. In one embodiment, the coil, for example, the one initially coated with plastic and subsequently formed into a coil, is, as a coiled ribbon, coated with plastic a second time.

The coiling of the ribbons to coils, according to one embodiment, creates an extraordinary elasticity with enormous mechanical resilience. As a result, an excellent adaptability to the surroundings in the body is achieved. Furthermore, they reliably withstand constant cardiac movement.

With the various options for plastic insulation, the mechanical properties of the cable can be further optimized for specific applications.

According to one embodiment, coil-shaped electrical leads for cardiac pacemakers provide various options for electrical insulation with plastic, which provide different intended uses in an unforeseeable scope.

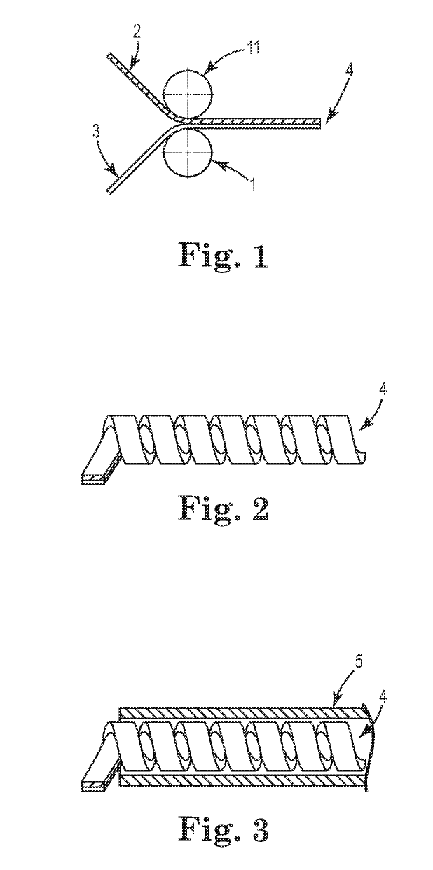

For the manufacture of a laminate in accordance with FIG. 1, at least 2 ribbons of varying metals (2 and 3) are laminated to a ribbon (4) by means of 2 rollers (1). The roll cladding of only two ribbons impresses with the simplicity of the method. Roll cladding with three ribbons allows for sandwich structures. The roll cladding causes cold welding between the materials, whereby the varying metals adhere to each other. In order to further improve the contact between the materials, additional heat can be applied. This supports the diffusion of the atoms in the border area of the materials. In one embodiment, the ribbon is coated after roll cladding with an elastic, electrically insulating, biocompatible plastic. Thereby, the biocompatibility is improved.

In accordance with FIG. 2, the ribbon is formed into a coil (4), which is fused with plastic (5), in accordance with FIG. 3. Alternatively, it has proven successful to coil the laminate onto a rod and to coat the coil thereupon with plastic, or to fuse to a tube, in accordance with FIG. 3.

Finally, the insulated ribbon, as ribbon, tube or rod, is connected on one end to the electrode and on the other end to a plug for the cardiac pacemaker.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A coil comprising:
a laminate comprising metal layers;
wherein the coil is configured for the electrical connection of stimulation electrodes; and
wherein one of the metal layers exhibits good electrical conductivity and another metal layer great mechanical strength.

2. The coil of claim 1, wherein one metal layer comprises a niobium or tantalum-based metal.

3. The coil of claim 1, wherein the niobium or tantalum-based metal is doped with at least one element from a group comprising P, B, O, C, N, Si, F, Zr, Y, La, Ce, Pr, Nd, Sm, Eu, Gd, Tb, Dy, Ho, Er, Tm, Yb, and Lu.

4. The coil of claim 1, wherein the metal with great strength is an alloy.

5. The coil of claim 1, wherein the material with great strength is based on the elements niobium or tantalum and contains at least one additional element from a group comprising tantalum, niobium, tungsten, and zirconium, or is a precipitation hardening steel, or a cobalt-chromium alloy, or a titanium alloy.

6. The coil of claim 1, wherein the outer circumference of the coiled laminate comprises the metal with greater mechanical strength.

7. The coil of claim 1, wherein the metal with good conductivity is selected from a group comprising silver, gold, copper, aluminum, and platinum.

8. The coil of claim 1, wherein the metal with good electrical conductivity is an element with high purity.

9. The coil of claim 1, configured for application of a cable for stimulation electrodes.

10. The coil of claim 1, configured as an electrical cable and further comprising a material with good electrical conductivity and another material with great strength, wherein the coil is configured within an electrical insulation, and wherein the cable exhibits a laminate of two metals, one of which exhibits good electrical conductivity and the other one great mechanical strength.

11. A laminate for manufacturing a coil comprising:
A plurality of metal layers;
wherein one of the metal layers exhibits good electrical conductivity and another metal layer great mechanical strength;
wherein one metal layer comprises elements niobium or tantalum and comprises at least one additional element from a group comprising tantalum, niobium, tungsten, and zirconium, or is a precipitation hardening steel, or a cobalt-chromium alloy, or a titanium alloy.

12. A method of manufacturing a coil comprising:
laminating at a first metal layer to a second metal layer;
wherein the first metal layer is based on niobium or tantalum, or a precipitation hardening steel, or a cobalt-chromium alloy, or a titanium alloy;
wherein that second metal layer exhibits a better electrical conductivity or greater mechanical strength than the first metal layer;
wherein the laminating produces a laminated ribbon; and
forming the laminated ribbon into a coil.

13. The method of claim 12, wherein the first metal layer based on niobium or tantalum-based metal is doped with at least one element from a group comprising P, B, O, C, N, Si, F, Zr, Y, La, Ce, Pr, Nd, Sm, Eu, Gd, Tb, Dy, Ho, Er, Tm, Yb, and Lu.

14. The method of claim 12, wherein the layer with great strength is an alloy.

15. The method of claim 12, wherein the outer circumference of the coiled laminate comprises the metal with greater mechanical strength.

16. The method of claim 12, wherein the layer with good conductivity is selected from a group comprising silver, gold, copper, aluminum, and platinum.

17. A method of manufacturing an electrical cable comprising:
laminating two different metals onto each other forming a laminated ribbon;
wherein one of the metals exhibits good electrical conductivity and the other one great mechanical strength;
coating the laminated ribbon with an electrically insulating plastic; and
forming the laminated ribbon into a coil.
